(19) United States
(12) Patent Application Publication
(10) Pub. No.: US 2012/0062808 A1
(43) Pub. Date: Mar. 15, 2012

(54) CHOLESTERIC LIQUID CRYSTAL DISPLAY DEVICE AND SIMPLE MATRIX DRIVING METHOD

(75) Inventors: Tomohisa SHINGAI, Machida (JP); Masaki NOSE, Kawasaki (JP); Hirokata UEHARA, Kawasaki (JP)

(73) Assignee: FUJITSU LIMITED, Kawasaki (JP)

(21) Appl. No.: 13/226,855

(22) Filed: Sep. 7, 2011

(30) Foreign Application Priority Data
Sep. 13, 2010 (JP) 2010-204631

(51) Int. Cl. G02F 1/133

(52) U.S. Cl. 349/33

(57) ABSTRACT

A cholesteric liquid-crystal display device includes a cholesteric liquid-crystal display element having common electrodes and segment electrodes; a common driver which drives the common electrodes, outputs a selected-line voltage to a selected line of the common electrodes, and outputs an unselected-line voltage to unselected lines other than the selected line; a segment driver which drives the segment electrodes and outputs a write signal to the segment electrodes; a drive controlling circuit which controls the common driver and the segment driver to rewrite an image displayed on the cholesteric liquid-crystal display element; and a voltage correcting circuit which corrects the unselected-line voltage corresponding to the write signal during writing to the selected line.

### CROSS-REFERENCE TO RELATED APPLICATIONS

This application is based upon and claims the benefit of priority of the prior Japanese Patent Application No. 2010-204631, filed on Sep. 13, 2010 the entire contents of which are incorporated herein by reference.

### FIELD

The present invention relates to a cholesteric liquid-crystal display device and a simple matrix driving method for a cholesteric liquid-crystal display element.

### BACKGROUND

Cholesteric liquid crystal has been attracting attention as a promising system for electronic paper (especially, color), because of its superior features of semi-permanent display retention (memorization), vivid color display, high contrast, and high resolution. Display elements utilizing cholesteric liquid crystal generally have a simple matrix (passive matrix) structure and are driven by a simple matrix driving method. The simple matrix liquid-crystal display element has an upper substrate having upper electrodes provided parallel to each other and a lower substrate having lower electrodes provided parallel to each other. The upper substrate and the lower substrate are disposed in an opposing manner so that the upper electrodes and the lower electrodes are perpendicular to each other. The simple matrix liquid-crystal display element further has a liquid crystal layer having cholesteric liquid crystal contained between the upper substrate and the lower substrate.

In the simple matrix driving method, the segment driver drives either the upper electrodes or the lower electrodes, and the common driver drives the other. In this simple matrix driving method, the electrodes driven by the segment driver are referred to as “segment electrodes” and the electrodes driven by the common driver are referred to as “common electrodes”. The common driver sequentially applies a selection voltage to the common electrodes while shifting the application position and applies a non-selection voltage to the common electrodes other than the common electrode to which the selection voltage is applied. The segment driver applies an ON voltage or an OFF voltage in accordance with image data for a write line corresponding to the common electrode to which the selection voltage is applied. A voltage having a large difference between the selection voltage and the ON voltage is applied to the ON pixels on the write line to perform writing, so that the state of the liquid crystal changes; and on the other hand, a voltage having a small difference between the selection voltage and the OFF voltage is applied to the OFF pixels on the write line, so that the state of the liquid crystal does not change. A voltage having a difference between the non-selection voltage and the ON voltage or OFF voltage is applied to the non-write lines for the common electrodes to which the non-selection voltage is applied. The selection voltage, the non-selection voltage, the ON voltage, and the OFF voltage are set so that the state of the liquid crystal in the ON pixels on the write line is sufficiently changed and the state of the liquid crystal in the OFF pixels on the write line and at the non-write line does not change. In general, voltages applied to the pixels of the non-write lines are referred to as “crosstalk voltages”, which are set lower than or equal to a threshold voltage at which the state of the liquid crystal is changed.

Methods for driving the cholesteric liquid-display display element are broadly classified into a conventional driving method and a dynamic driving method. The dynamic driving method allows a displayed image to be rewritten at relatively high speed, but has a problem in that it is difficult to achieve fine gradation display. In contrast, the conventional display method allows for fine gradation display, but has a problem in that a large amount of time is required for rewriting a displayed image. This disclosure is directed to a display device and a display method that drives a cholesteric liquid crystal display element by using a conventional driving method.

In the conventional driving, a reset operation is performed to put all pixels into a planer state or a focal conic state. Thereafter, in the simple matrix driving method, a write pulse with a relatively small voltage and with a small pulse width is applied to perform a write operation for changing, for each of the pixels, the state thereof from the planer state or the focal conic state. For example, when the reset state is changed to the planer state, a write pulse is applied to change the planer state to the focal conic state. When energy of the write pulse is large, a majority of the liquid crystal in the pixels changes to the focal conic state. When energy of the write pulse is small, the liquid crystal in the pixels partly changes to the focal conic state, so that the focal state and the focal conic state coexist to allow for a halftone display. The energy of the write pulse may be changed by changing and adjusting the voltage (the wave height) of the write pulse or a cumulative pulse application time; and the cumulative pulse application time may be changed by changing the pulse width, the number of pulse applications, or both thereof.

Although the segment driver and the common driver are typically realized using general-purpose driver ICs due to cost, cholesteric liquid crystal has a low response speed when it is driven with voltages that can be output by the general-purpose driver ICs. Accordingly, when the conventional driving is employed to drive the cholesteric liquid crystal display element, the reset operation can be performed in a relatively short period of time since it is simultaneously performed on all pixels. However, the write operation requires a long period of time since it is performed for each line, so that the output period of a selection voltage for one line is closer to a visible period that is a limit of luminance variations perceivable by humans.

As described above, in the simple matrix driving method, a crosstalk voltage is applied to all of the pixels on a non-write line and the crosstalk voltage is set lower than or equal to a threshold voltage at which the state of liquid crystal is changed. The crosstalk voltages, however, vary depending on image data for the write line (e.g., whether the write data is for white or black or the ratio of the number of white pixels versus the number of black pixels) to thereby cause brightness of the pixels to be changed by a small amount even when the crosstalk voltage is lower than or equal to the threshold voltage.

In such a manner, the brightness of areas of the non-write lines (the unselected lines) during image writing randomly varies in a period of writing to one line in accordance with a crosstalk voltage difference. As described above, when the cholesteric liquid crystal display element is driven by the conventional driving, the output period of a selection voltage for one line comes closer to the visible period. The random brightness variation is thus perceived as a flicker phenomenon.

In order to reduce the flicker phenomenon, a power supply for the non-selection voltage is generally provided with a large-capacity decoupling capacitor. However, when the display element is large, a large-capacity decoupling capacitor needs to be used in order to sufficiently suppress flicker, thereby causing problems in that, for example, the cost is high, the component size (particularly, the thickness) is large, and a large amount of power is wasted in the sleep mode.

Related art is disclosed in Japanese Laid-open Patent Publication No. 2000-250488, Japanese Laid-open Patent Publication No. 11-184436, Japanese Patent No. 3713954, Japanese Laid-open Patent Publication No. 2006-330035, Japanese Laid-open Patent Publication No. 2008-268566, and U.S. Pat. No. 5,453,863.

### SUMMARY

According to one aspect of the invention, a cholesteric liquid-crystal display device includes a cholesteric liquid-crystal display element having common electrodes and segment electrodes; a common driver that drives the common electrodes, outputs a selected-line voltage to a selected line of the common electrodes, and outputs an unselected-line voltage to unselected lines other than the selected line; a segment driver that drives the segment electrodes and outputs a write signal to the segment electrodes; a drive controlling circuit that controls the common driver and the segment driver to rewrite an image displayed on the cholesteric liquid-crystal display element; and a voltage correcting circuit that corrects the unselected-line voltage corresponding to the write signal during writing to the selected line.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B illustrate states of cholesteric liquid crystal;

FIG. 2 illustrates an example of a state transition of liquid crystal in a conventional driving method;

FIGS. 3A to 3F illustrate examples of a voltage waveform applied to a liquid crystal cell (a pixel) in the conventional driving method and examples of a reflectance response characteristic when the illustrated voltage waveform is applied;

FIG. 4 illustrates examples of a characteristic of voltage response to pulses with various pulse periods when the initial state is the planer state;

FIG. 5 illustrates the basic configuration of a simple matrix display element;

FIGS. 6A to 6D illustrate a simple matrix liquid-crystal device including three common electrodes and three segment electrodes and having three pixels high by three pixels wide, voltages output from a common driver and a segment driver, and voltages applied to the liquid crystal;

FIG. 7 illustrates non-selection voltage dependency of a typical voltage response characteristic of the cholesteric liquid-crystal display element and illustrates amounts of decrease in the luminance (Y value) from the planer state (i.e., white: a light state) when the non-selection voltage is varied using the number of applications as a parameter;

FIG. 8 illustrates the configuration of an output portion for the common driver and the segment driver, output voltage waveforms, and voltage waveforms applied to the liquid crystal;

FIG. 9 illustrates a voltage response characteristic of an actual cholesteric liquid-crystal panel;

FIG. 10 is a block diagram illustrating a schematic configuration of a cholesteric liquid-crystal display device according to a first embodiment;

FIG. 11 illustrates the structure of the display element;

FIG. 12 illustrates a basic configuration of one panel;

FIG. 13 is a diagram illustrating the structure of an output portion of a voltage corrector, a voltage generator, a voltage stabilizer, a common driver, and a segment driver in the first embodiment;

FIG. 14 illustrates voltage waveforms output by the common driver and the segment driver in the first embodiment and voltage waveforms applied to liquid crystal pixels LC;

FIG. 15 is a diagram illustrating voltages applied to capacitances for the liquid crystal pixels when the common driver and the segment driver drive the liquid crystal display element;

FIGS. 16A and 16B illustrate states of driving of the liquid crystal display element;

FIGS. 17A to 17D illustrate the states of circuits for calculating changes due to power supplied from terminals;

FIG. 18 illustrates changes in voltages in corresponding units based on calculation results;

FIG. 19 illustrates a model of changes in the voltage applied to the liquid crystal pixels when the ratio of black pixels versus white pixels in the pixel data is half and half for application of a positive pulse; and

FIG. 20 is a block diagram of a schematic configuration of a cholesteric liquid crystal display device according to a second embodiment.

### DETAILED DESCRIPTION OF THE EMBODIMENTS

Before embodiments of the present invention are described, a description will be given of cholesteric liquid crystal, a simple matrix driving method, and a conventional driving method.

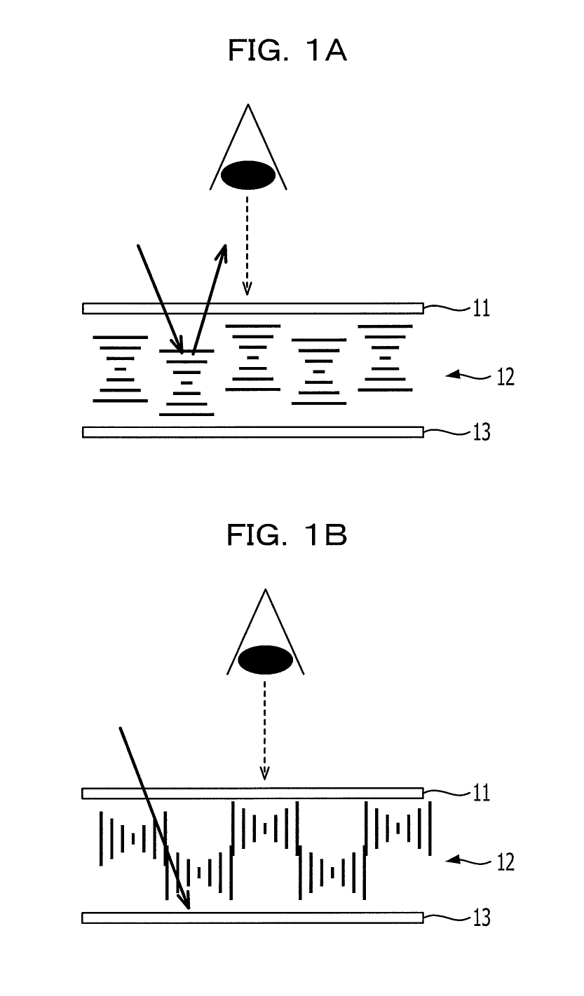

FIGS. 1A and 1B illustrate states of a cholesteric liquid crystal. As illustrated in FIGS. 1A and 1B, a display element 10 using cholesteric liquid crystal has an upper substrate 11, a cholesteric liquid crystal layer 12, and a lower substrate 13. The cholesteric liquid crystal has a planer state in which incident light is reflected as illustrated in FIG. 1A and a focal conic state in which incident light is reflected as illustrated in FIG. 1B. These states are stably maintained even under no electric field. In addition, the cholesteric liquid crystal has a homeotropic state in which upon application of a strong electric field, all liquid crystal molecules are oriented in the direction of the electric field. Upon end of application of the electric field, the homeotropic state changes to the planer state or the focal conic state.

In the planer state, the cholesteric liquid crystal reflects light with a wavelength corresponding to the helical pitch of the liquid crystal molecules. Letting n be an average refractive-index of the liquid crystal and letting p be the helical pitch, a wavelength λ at which the reflection is maximized is expressed by the following expression.

λ=n·p

A reflection band Δλ increases in conjunction with a refractive-index anisotropy Δn of the liquid crystal.

In the planar state, a “light” state (i.e., white) can be displayed since incident light is reflected. On the other hand, provision of a light absorption layer below the lower substrate 13 allows a “dark” state (i.e., black) to be displayed in the focal conic state, since light passing through the liquid crystal layer 12 is absorbed by the light absorption layer.

Next, a description will be given of a principle of driving a display element utilizing cholesteric liquid crystal.

When a strong electric field is applied to the liquid crystal, the helical structure of liquid crystal molecules is completely unwound and the liquid crystal enters the homeotropic state in which all of the molecules are oriented in the direction of the electric field. Subsequently, when the electric field is rapidly reduced to zero in the homeotropic state, the helical axis of the liquid crystal is oriented perpendicular to electrodes and the liquid crystal enters the planer state in which light corresponding to the helical pitch is selectively reflected. When an electric field that is weak to a degree at which the helical structure of the liquid crystal molecules is not unwound is formed and is then removed or when a strong electric field is applied and is then gradually removed, the helical structure of the liquid crystal becomes parallel to the electrodes and the liquid crystal enters the focal conic state in which light is allowed to pass therethrough. When a medium-strength electric field is applied and is then rapidly removed, the planer state and the focal conic state coexist to allow for halftone display. This phenomenon is utilized to display information.

A large number of methods have been proposed as driving methods used for displaying an image on a cholesteric liquid crystal display element. The driving methods are broadly grouped into two methods: a conventional driving method and a dynamic driving method. The dynamic driving method employs a transient planer state, in addition to the above-described homeotropic state, the planer state, and the focal conic state. The dynamic driving method allows a displayed image to be rewritten at a relatively high speed, but has a problem in that it is difficult to achieve a fine gradation display. In contrast, the conventional display method allows for fine gradation display, but has a problem in that a large amount of time is required for rewriting a displayed image. The technology disclosed herein is directed to a display device and a display method that drive a cholesteric liquid crystal display element by using a conventional driving method and is not aimed at a driving method and a display method using the dynamic driving method.

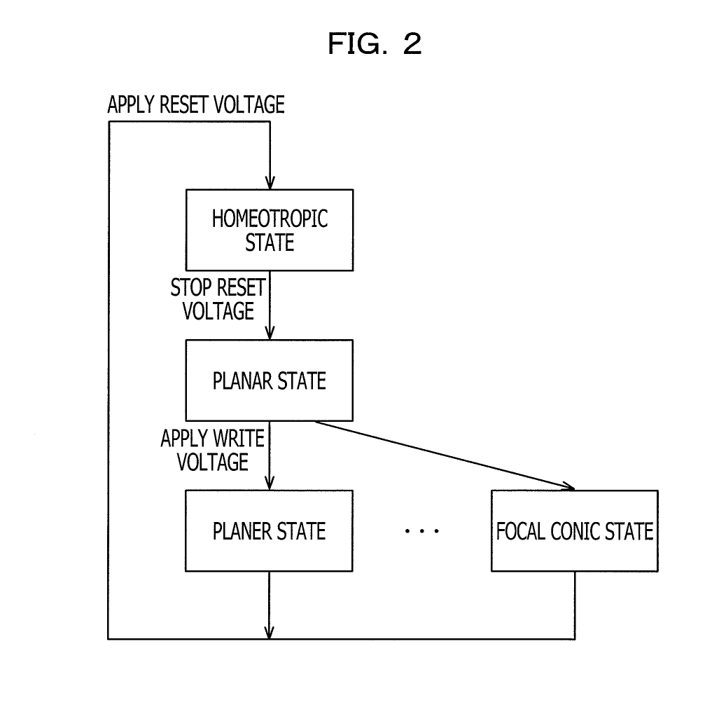

FIG. 2 illustrates an example of a state transition of a liquid crystal in the conventional driving method. In the conventional driving method, after a high voltage is applied to all pixels to put them into the homeotropic state, the electric field is removed to perform a reset operation for placing all of the pixels into the planer state or the focal conic state. Thereafter, in the simple matrix driving method, a write pulse with a relatively low voltage and with a small pulse width is applied to perform a write operation for changing the state from the planer or focal conic state pixel by pixel. FIG. 2 illustrates an operation in which after all the pixels are placed into the planer state by the reset operation, the state of the pixels is maintained in the planer state, is changed to the focal conic state, or is changed to a state in which the planer state and the focal conic state coexist.

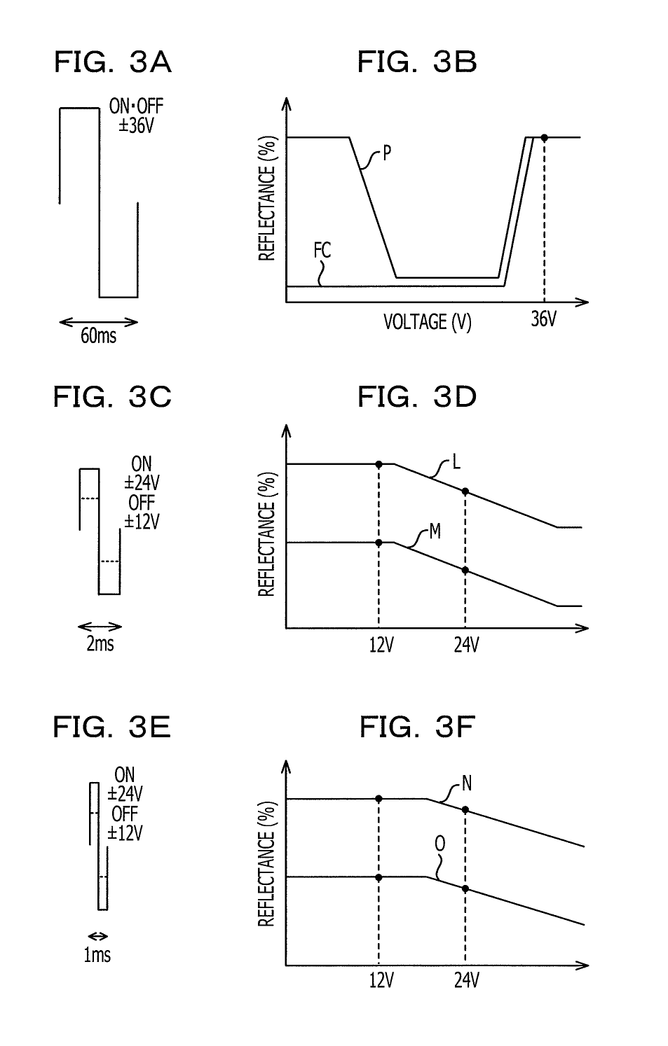

FIGS. 3A to 3F illustrate examples of a voltage waveform applied to a liquid crystal cell (a pixel) in the conventional driving method and examples of a reflectance response characteristic when the illustrated voltage waveform is applied. FIG. 3A illustrates a reset voltage waveform (pulse) applied in the reset operation; and FIG. 3B illustrates a response to an application of the reset pulse. FIG. 3C illustrates one example of a write voltage waveform (pulse) applied in the write operation; and FIG. 3D illustrates a response to an application of the write pulse in FIG. 3C when the initial state is the planer state. FIG. 3E illustrates a write pulse with a smaller pulse width than the pulse width illustrated in FIG. 3C; and FIG. 3F illustrates a response to an application of the write pulse in FIG. 3E when the initial state is the planer state. In other words, FIGS. 3D and 3F illustrate changes at a left slope portion denoted by P in FIG. 3B.

The drive waveform of cholesteric liquid crystal needs to be an alternating waveform in order to suppress deterioration (polarization) of the liquid crystal material, as in a typical liquid crystal. Thus, a liquid-crystal driver IC (which is typically implemented by an IC dedicated to cholesteric liquid crystal or an IC for STN (super-twisted nematic) liquid crystal has a function for inverting the polarity of an electric field applied to the liquid crystal cells and a high-voltage power supply for driving the liquid crystal may be implemented by a positive single power supply with several tens of voltages.

First, a description will be given of a state transition that occurs when a pulse with a positive-and-negative-pulse width of 60 ms, which is a large pulse width, as illustrated in FIG. 3A, is applied and the pulse voltage is gradually increased from 0 V. When the initial state is the planer state, the state changes along a line denoted by P in FIG. 3B. When the pulse voltage exceeds a certain voltage, the state gradually changes to the focal conic state, and the reflectance declines sharply. When the reflectance reaches its minimum value, the reflectance exhibits almost no change unless the pulse voltage exceeds the certain voltage. When the pulse voltage exceeds the certain voltage, the state gradually changes to the planer state and the reflectance sharply increases. Once the reflectance reaches its maximum value, the reflectance does not change even when the pulse voltage is increased. Such a voltage-to-reflectance characteristic is generally referred to as a “V-R characteristic”. When the initial state is the focal conic state, the state changes along a line denoted by FC in FIG. 3B. The reflectance does not change unless the pulse voltage exceeds a certain voltage. When the pulse voltage exceeds the certain voltage, the state gradually changes to the planer state and the reflectance sharply increases. Once the reflectance reaches its maximum value, the reflectance does not change even when the pulse voltage is increased. Regardless of whether the initial state is the planer state or the focal conic state, an application of a voltage exceeding the certain voltage causes the state to inevitably change to the planer state in which the reflectance has the maximum value. In FIG. 3B, for a pulse with a pulse width of 60 ms and with a voltage of ±36 V, the state to the planar state inevitably changes; and therefore, this pulse can be used as a reset pulse.

When a pulse with a smaller pulse width than that pulse width is applied, the responsiveness shifts. For example, for an application of pulses (as illustrated in FIG. 3C) with a pulse width of 2 ms and with pulse voltages of ±24 V and ±12 V, when the initial state is the planer state, the state changes along a line denoted by L in FIG. 3D. In FIG. 3D, the reflectance does not change with the pulse of ±12 V and the planer state is maintained. With the pulse of ±24 V, a halftone at which the reflectance decreases slightly is obtained. When the initial state is a state in which the planer state and the focal conic state coexist (i.e., is a state in which the reflectance has an intermediate value), the state changes along a line denoted by M in FIG. 3D. Also, in this case, with the pulse of ±12 V, the reflectance does not change, and with the pulse of ±24 V, the reflectance decreases slightly.

In addition, for an application of pulses (illustrated in FIG. 3E) with a pulse width of 1 ms and with pulse voltages of ±24 V and ±12 V, when the initial state is the planer state, the state changes along a line denoted by N in FIG. 3F. In FIG. 3F, the reflectance does not change with the pulse of ±12 V and the planer state is maintained. With the pulse of ±24 V, a halftone at which the reflectance decreases slightly is obtained. However, the amount of decrease in the reflectance is smaller than the amount of decrease with the pulse width of 2 ms. That is, the gradation for the pulse with a pulse of 2 ms is darker than the gradation for the pulse with a pulse width of 1 ms. When the initial state is a state in which the planer state and the focal conic state coexist (i.e., is a state in which the reflectance has an intermediate value), the state changes along a line denoted by O in FIG. 3F. Also, in this case, with the pulse of ±12 V, the reflectance does not change, and with the pulse of ±24 V, the reflectance slightly decreases.

It can be understood that, when the initial state is the planer state, the reflectance decreases upon the application of a pulse with a relatively small voltage and with a small pulse width and the amount of decrease in the reflectance varies according to the pulse voltage and the pulse width, as described above. Specifically, the higher the pulse voltage is and the larger the pulse width is, the larger the amount of decrease in the reflectance. The changes indicated by M in FIGS. 3D and O in FIG. 3F indicate that a similar change occurs even when pulses are separately applied and the amount of decrease in the reflectance is related to a total pulse width (i.e., a cumulative pulse application time).

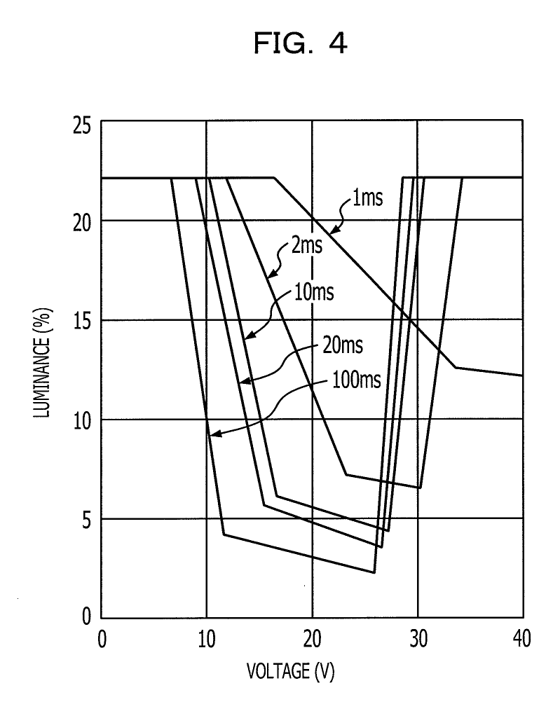

FIG. 4 illustrates an example of a characteristic of voltage response to pulses with various pulse widths when the initial state is the planer state. The minimum value of luminance associated with the reflectance changes considerably, depending on the pulse period. As the pulse period increases, a smaller luminance is reached with a lower voltage. Thus, a larger pulse period is necessary in order to provide dark black.

Although the above description has been given of an example in which the initial state is the planer state and the left slope portion denoted by P in FIG. 3B is utilized, a similar description also applies to a case in which the initial state is the focal conic state and the right slope portion denoted by FC in FIG. 3B is utilized.

Some methods have been proposed as the conventional driving method.

In a first method, a reset operation is initially performed to put all pixels into the planer state. Next, a write operation is performed to apply a write pulse, so that the reflectance changes from a higher level to a lower level and the pixels enter the focal conic state. Adjusting energy of the write pulse by changing the voltage of the write pulse, the cumulative pulse application time, or the like allows halftones to be displayed with an adjusted amount of decrease in the reflectance. In other words, in the first method, the left slope portion denoted by P in FIG. 3B is utilized in the write operation.

A second method is an FCR (focal conic reset) method in which all pixels are temporarily put into the planer state by the reset operation and are then put into the focal conic state at once. In the FCR method, the right slope portion denoted by FC in FIG. 3B is utilized in the write operation. Upon application of a write pulse, the reflectance increases along the right slope portion at which the reflectance changes from a lower level to a higher level and the state changes to the planer state as shown at the upper right in FIG. 3B. Adjusting energy of the write pulse by changing the voltage of the write pulse, the cumulative pulse application time, or the like allows halftones to be displayed with an adjusted amount of increase in the reflectance.

In a third method, after the reset operation is performed to place the pixels into the focal conic state, all pixels other than the pixels to be maintained in the focal conic state for black display are placed into the planer state through the use of the right slope portion denoted by FC in FIG. 3B. Thereafter, in the third method, the state of the pixels is changed to a desired halftone state through the use of the left slope portion denoted by P in FIG. 3B.

In the second method (the FCR method), since the high-speed state transition (indicated by the right slope portion denoted by FC in FIG. 3B) from the focal conic state to the planer state is performed line by line, the write operation can be performed at a relatively high speed. For example, when the display element is assumed to have 1000 lines and performs scanning at a scan speed of 4 ms/line, the amount of time for the scanning is 4 seconds. Accordingly, even when an application time of about 200 ms needed to achieve high contrast is required to put all pixels into the focal conic state, there is almost no effect on the overall display time. However, for the implementation of the FCR method, a high voltage of about 100 V is required and a general-purpose driver IC is not usable, which becomes expensive.

In the FCR method, the transition from the initial state in which the planer state and the focal conic state coexist to the focal conic state is performed at all pixels at once over a relatively long period of time, it is possible to achieve favorable black (high contrast) display. The FCR method is a system in which the transition from the focal conic state to the planer state is performed line by line through the use of the right slope portion denoted by FC in FIG. 3B. Since the right slope portion exhibits a significantly steep voltage response characteristic, the FCR method realizes favorable white display but has problems in that the brightness of halftones is unstable and uneven, and the reproducibility of halftones is insufficient.

In the third method, since the binary display is initially performed over a long period of time, the contrast is favorable, and since the left slope portion denoted by P in FIG. 3B is utilized in the write operation, favorable halftones can be displayed. However, since the binary display and the halftone display are separately performed, the third method has a problem with halftone continuity. For reducing the brightness to a level that is close to binary-represented black in order to achieve halftone continuity, a pulse width of at least 20 ms/line is needed and there is a problem in increasing the display speed. When the display panel is assumed to have 1000 lines and the FCR method is used for the binary display, typically, a total display time is 24 seconds, with 4 seconds for the binary display and 20 seconds for the halftone display.

In the first method, since the gentle left slope portion denoted by P in FIG. 3B is utilized, the halftone continuity can be maintained to allow for a favorable halftone display. However, a reduction in the brightness to a certain degree of black requires a speed of at least 10 ms/line and has difficulty in achieving high-speed display. For example, when the display panel is assumed to have 1000 lines, the display time is typically 10 seconds. In the first method, since no binary display is initially performed, the halftone continuity is favorable. However, compared to the second and third methods, the contrast is slightly low, which poses a technical challenge in enhancing the contrast. In other words, compared to the second method, the third method improves the display speed at the expense of the contrast.

While some conventional driving methods are available as described above, each method has advantages and drawbacks and may be selected depending on the application. An embodiment, which is also applicable to any of the conventional methods described above, will be described below in conjunction with an example of a case in which the first method is used. The first method will be simply referred to as a “conventional driving method” hereinafter.

A simple matrix (passive matrix) driving method will be described next.

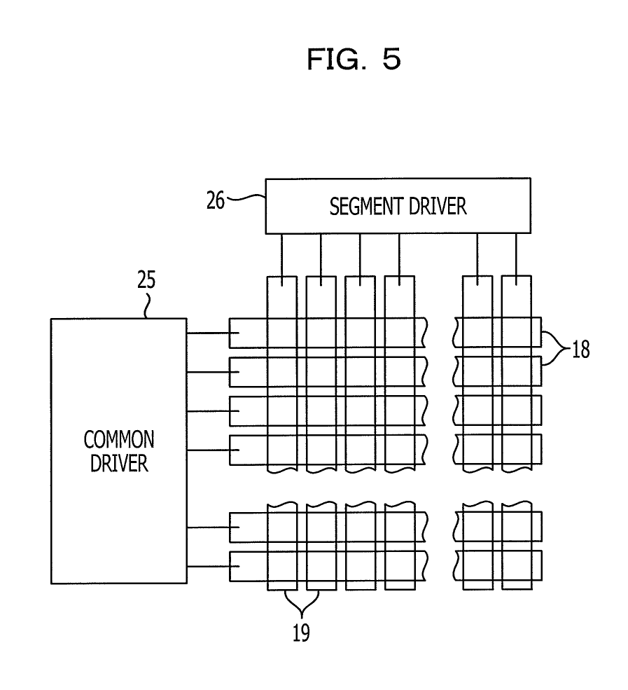

FIG. 5 illustrates a basic configuration of a simple matrix display element. The simple matrix display element has common electrodes 18 extending horizontally in parallel, segment electrodes 19 extending vertically in parallel, a common driver 25 for driving the common electrodes 18, and a segment driver 26 for driving the segment electrodes 19. The common electrodes 18 are transparent electrodes provided on one transparent substrate, as described below. The segment electrodes 19 are transparent electrodes provided on another transparent substrate. The two substrates are disposed in an opposing manner so that the common electrodes 18 and the segment electrodes 19 are perpendicular to each other. A liquid-crystal layer enclosing cholesteric liquid crystal is disposed between the two substrates. Pixels are disposed at the intersections of the common electrodes 18 and the segment electrodes 19.

An example of a simple matrix liquid-crystal device having 3 pixels high by 3 pixels wide will be described below for simplicity of description.

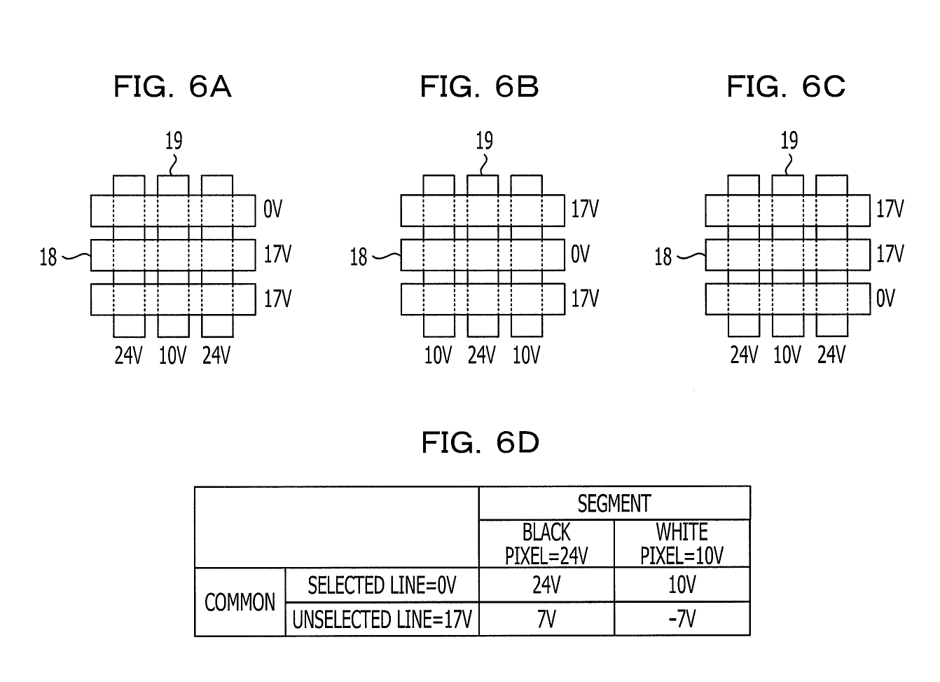

Each of FIGS. 6A to 6C illustrates a simple matrix liquid-crystal device having 3 pixels high by 3 pixels wide, voltages output from the common driver 25 and the segment driver 26, and voltages applied to the liquid crystal. The illustrated simple matrix liquid-crystal device has three common electrodes 18 and three segment electrodes 19. FIGS. 6A to 6C illustrate a case in which a checkerboard pattern is written.

As illustrated in FIGS. 6A to 6C, for driving the simple matrix liquid-crystal device, the common electrodes 18 are sequentially selected (typically, 0 V) line by line and then a voltage s (typically, two types of voltages) corresponding to the pixels on the selected line is applied to all of the segment electrodes 19. FIG. 4 for which the description has been given above illustrates a voltage response characteristic with respect to the various pulse widths of the liquid crystal device.

Assuming that the initial state of all of the pixels in the liquid crystal device in FIGS. 6A to 6C is the planer state (i.e., white) and a pulse with a pulse width of 10 ms is applied to write black to all of the pixels on which black is to be displayed. A voltage of 0 V is applied to the selected common electrodes. A Y value (luminance), associated with the reflectance, reaches its lowest value (i.e., the darkest black state) at 24 V, as indicated by the characteristic of 10 ms in FIG. 4. Thus, 24 V is applied to the segment electrodes for the black pixels. As described below, a crosstalk voltage given by ±(24−Vw)/2 is applied to the pixels on the common electrodes that are not selected, where Vw indicates a voltage applied to the white pixels. In order to minimize the crosstalk, Vw needs to have the largest possible value. Since the voltage range in which the Y value does not decrease and whiteness can be maintained is 0 to 10 V, as indicated by the characteristic of 10 ms in FIG. 4, Vw is set to 10 V. Thus, the voltage to be applied to the common electrodes that are not selected is (24+Vw)/2)=17 V. Accordingly, +7 V relative to the common electrode 18 is applied to the unselected pixels at which the segment electrodes 19 are at 24 V, and −7 V relative to the common electrode 18 is applied to the unselected pixels at which the segment electrodes 19 are at 10 V.

As described above, the voltage applied to the liquid crystal needs to be an alternating voltage. In the first half (5 ms) of writing to each line, 24 V or 10 V is applied to the segment electrode 19 and 0 V or 17 V is applied to the common electrodes 18. Thus, 24 V, 10 V, 7 V, and −7 V are applied to the black pixels on the selected common electrodes; the white pixels on the selected common electrodes; the pixels on the segment electrodes; for the black pixels and on the unselected common electrodes, and the pixels on the segment electrodes for the white pixels and on the unselected common electrodes, respectively. In the last half (5 ms) of writing to each line, 0 V or 14 V is applied to the segment electrodes 19 and 24 V or 7 V is applied to the common electrodes 18. Thus, −24 V, −10 V, −7 V, and 7 V are applied to the black pixels on the selected common electrode; the white pixels on the selected common electrodes; the pixels on the segment electrodes for the black pixels and on the unselected common electrodes; and the pixels on the segment electrodes for the white pixels and on the unselected common electrodes, respectively.

Thus, the voltages applied to the liquid crystal are:

First half (5 ms): +24 V, +10 V, +7 V, and −7 V

Last half (5 ms): −24 V, −10 V, −7 V, and +7 V.

The voltages are made alternating regardless of the pixel states (selected, unselected, white, and black).

FIGS. 6A to 6C illustrate voltages applied in the first half (5 ms) of the writing. Performing the above-described operation while scanning the selected common electrodes across the screen from end to end allows an image to be written to the entire screen.

As is apparent from FIGS. 6A to 6C, the voltage is applied to the selected line once, whereas the voltage is applied to unselected lines Nc−1 times, where Nc is the number of common electrodes. It is thus important to pay attention to the fact that the unselected lines account for the majority. When the number of lines is small, as illustrated in FIGS. 6A to 6C, the influence of the voltage being applied to the unselected lines multiple times is small. However, in an XGA panel, the number of voltage applications to the unselected lines is 767, which has a significantly large influence.

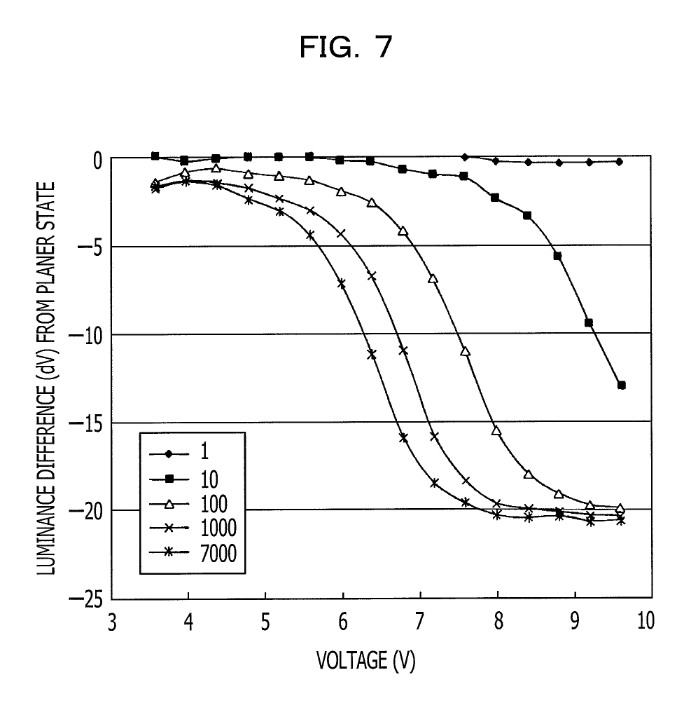

FIG. 7 illustrates non-selection voltage dependency of a typical voltage response characteristic of the cholesteric liquid-crystal display element and illustrates amounts of decrease in the luminance (Y value) from the planer state (i.e., white: a light state) when the non-selection voltage is varied using the number of applications as a parameter. The number of applications of the non-selection voltage is 1, 10, 100, 1000, and 7000.

As illustrated in FIG. 7, when the number of applications of the non-selection voltage is 1000 or more and the non-selection voltage exceeds about 5 V, the luminance decreases significantly. This influence is not limited to the white pixels and also significantly affects the black pixels. As the non-selection voltage increases, the brightness of white decreases and conversely, the brightness of black increases.

In the characteristic of 10 ms in FIG. 4, a threshold for transition from the planer state to the focal conic state with respect to one pulse with a pulse width of 10 ms is about 10 V. In FIG. 7, however, a threshold (an upper limit of the non-selection voltage) for transition from the planer state to the focal conic state with respect to 1000 pulses with a pulse width of 10 ms is as low as 5 V.

For a VGA panel, when it is assumed that that the non-selection voltage is 5 V and the voltage Vw applied to the white pixels on the selected line is 10 V, the voltage applied to the black pixels on the selected line (this voltage is hereinafter referred to as a “selection voltage”) is determined to be 20 V on the basis of FIG. 7. In the characteristic of 10 ms in FIG. 4, the Y value (luminance) at a selection voltage of 20 V is 5, whereas the Y value at a selection voltage of 20 V when the non-selection voltage is applied 767 times is considerably smaller than 5.

In the simple matrix driving method, the common driver 25 selects one line (one selected line) to which image data is to be written and the segment driver 26 applies an image data signal to all of the segment lines (the segment electrodes) that are perpendicular to the selected line, as illustrated in FIGS. 6A to 6C. At this point, a crosstalk voltage (±7 V in FIG. 7) that is lower than or equal to a threshold is applied to all of the pixels on the lines (the unselected lines) other than the selected line.

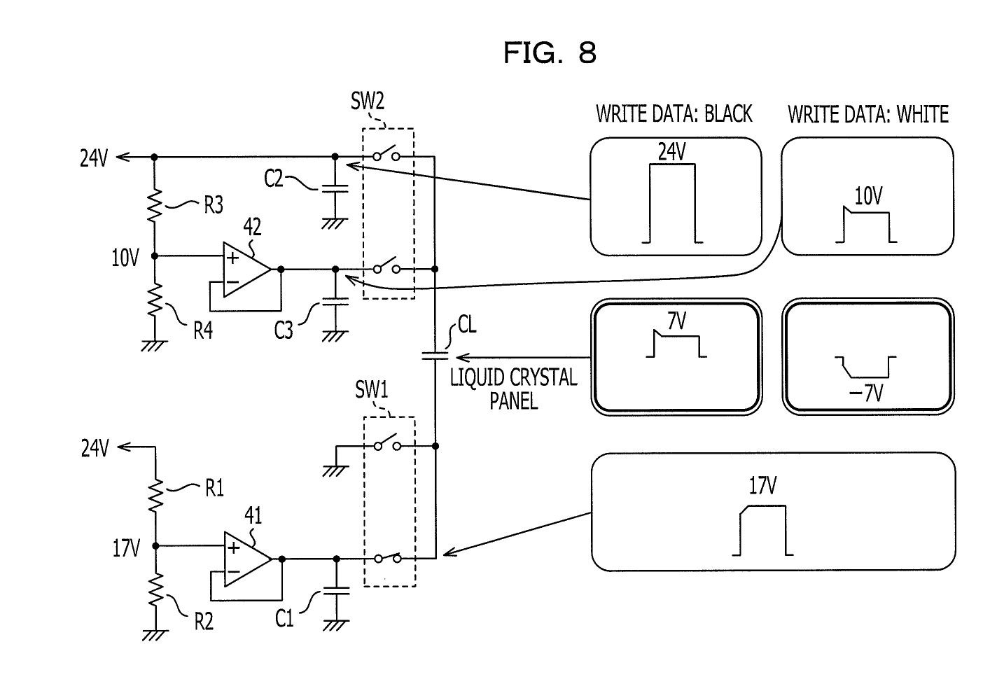

FIG. 8 illustrates the configuration of an output portion for the common driver 25 and the segment driver 26, output voltage waveforms, and voltage waveforms applied to the liquid crystal.

Resistors R1, R2, R3, and R4 and operational amplifiers 41 and 42 are elements constituting a voltage generator, which generates voltages to be output from the common driver 25 and the segment driver 26 and also achieves a necessary drive capability. Decoupling capacitors C1 to C3 are elements constituting a voltage stabilizer (described below), which stabilizes voltages to be output from the common driver 25 and the segment driver 26. The common driver 25 and the segment driver 26 have switches SW1 and SW2. The common driver 25 and the segment driver 26 have such switches according to the number of terminals and also have shift registers and so on (not illustrated) to control the operations of the switches. The liquid-crystal pixels are equivalent to capacitances and are indicated by CL. The states of the switches illustrated in FIG. 8 correspond to a case in which, in a scan operation during the write operation, an OFF voltage for the white pixels is applied from the segment driver 26 to the liquid crystal pixels CL on the unselected line. That is, a non-selection voltage of 17 V is applied from the common driver 25; an OFF voltage of 10 V for the white pixels is applied from the segment driver 26; and -7 V is applied to the liquid crystal pixels CL.

Right waveforms in FIG. 8 represent voltage waveforms of corresponding portions. The upper-left voltage waveform represents a waveform output when an ON voltage of 24 V for the black pixels is output from the segment driver 26. The upper-right voltage waveform represents a waveform output when an OFF voltage of 10 V for the white pixels is output from the segment driver 26. The voltage waveform at the lower side represents a waveform output when a non-selection voltage of 17 V is output from the common driver 25. The left voltage waveform at the middle represents a waveform applied to the liquid crystal pixels CL when an ON voltage of 24 V is output from the segment driver 26. The right voltage waveform at the middle represents a waveform applied to the liquid crystal pixels CL when an OFF voltage of 10 V is output from the segment driver 26. In other words, the left and right voltage waveforms at the middle represent crosstalk voltages applied to the liquid crystal pixels CL.

The crosstalk voltages applied to the pixels on the unselected lines vary depending on image data (e.g., depending on whether write data is white or black, the ratio of the number of white pixels versus the number of black pixels, and so on), as illustrated in FIG. 8, and may cause a large difference in the absolute values between the pixels.

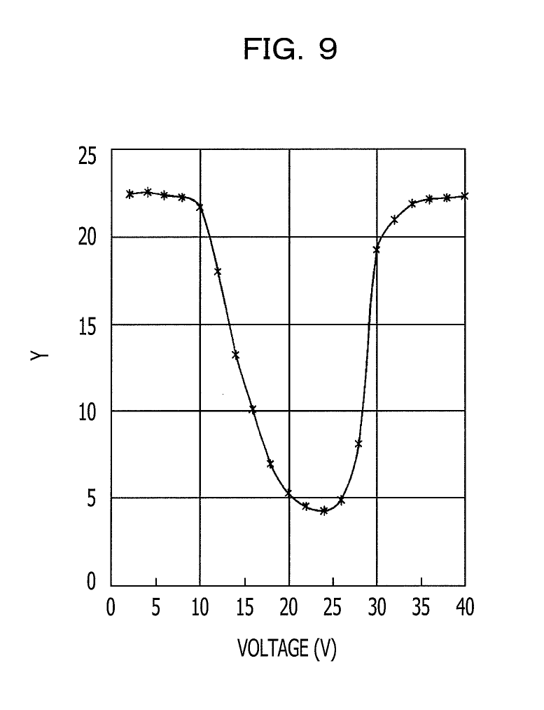

When the voltage response characteristic completely exhibits the same luminance in a range that is lower than or equal to the threshold (10 V in FIG. 4), as in the response characteristic for a pulse width of 10 ms in FIG. 4, the brightness of the pixels does not vary as long as the crosstalk voltage is lower than or equal to the threshold. However, the voltage response characteristic of an actual cholesteric liquid crystal panel exhibits a slight change in the luminance even in the range that is lower than or equal to the threshold (about 10 V), as illustrated in FIG. 9. Thus, even when the value of the crosstalk voltage is smaller than or equal to the threshold, the brightness of the pixels slightly varies according to the voltage applied. Hence, during the write operation, a phenomenon (flicker) occurs whereby the brightness of the unselected areas randomly varies according to a difference in the crosstalk voltage.

The variation in the crosstalk voltage is caused by a variation in the voltage of the power supply that supplies the nonselection voltage. Since the equivalent circuit for the liquid crystal has a large-capacity capacitor having a small resistance in series, an instantaneous voltage drop or surge in the non-selection voltage is inevitable during voltage switching at a time in which the selected line is updated.

The power-supply for the nonselection voltage requires both source and sink capabilities and is generally implemented by a voltage follower circuit using an operational amplifier 41, as illustrated in FIG. 8. Accordingly, when flicker suppression was highly necessary, the capacitance of the decoupling capacitor C1 was increased to a few times the electrostatic capacitance of the display element, as illustrated in FIG. 8. However, for a large-size display element, a large-capacity decoupling capacitor capable of sufficiently suppressing flicker is necessary, thereby causing problems , such as, high cost, large component size (particularly, the thickness) is large, and a large amount of waste in power in the sleep mode. Accordingly, it has been necessary for the actual display device to permit a certain degree of flicker.

An embodiment described blow provides a simple matrix driving method for a cholesteric liquid-crystal display element, which can eliminate flicker without the use of a large-capacity decoupling capacitor for the power supply for the non-selection voltage.

An instantaneous variation in the voltage in the unselected line is considered to be inevitable during voltage switching at a time when the selected line is updated. A reduction in the voltage variation requires a large-capacity decoupling capacitor. It is, however, found in practice that the instantaneous voltage variations themselves are invisible because they occur too rapidly. When the brightness is changed in a sinusoidal pattern, a time-to-frequency characteristic of visual perception of flicker is generally thought to permit flicker to be viewed when a frequency of 60 Hz (a repeating frequency of about 16.7 ms) is exceeded. The duration of the instantaneous voltage variation is generally the first few percent to ten percent of the time of driving the selected line.

The second method of the above-described conventional driving methods has the largest selected-line drive period. Even in the second method, the line drive period is about 20 ms and thus the maximum voltage variation is about 2 ms. Since a brightness variation exceeding 60 Hz is invisible as described above, flicker can be reduced even without a reduction in the brightness variation. A result of an experiment confirmed that no flicker occurs when components included in a frequency range of about 0 to 60 Hz, out of the effective values of the non-selection voltage, are substantially constant. That is, if a cumulative value of variations in the effective value of the non-selection voltage in a longer period than 16.7 ms can be canceled, no flicker occurs regardless of the instantaneous voltage variation.

Accordingly, in an embodiment described below, regardless of the voltage variation, the effective value of the pulse applied in the visible time (16.7 ms or more) is made constant to thereby reduce flicker. The reason why such an approach is possible is that the response of the liquid crystal exhibits high linearity with respect to the cumulative electrical energy of the pulse applied. In this embodiment, correction for making the effective value constant is individually performed for each applied pulse.

In other words, the correction is performed by correcting the non-selection voltage output by the common driver and the voltage output by the segment driver so that components that are lower than or equal to the visible frequency of the effective value of the voltage applied to the pixels on the unselected lines become constant, regardless of a shorter voltage variation than the period for the visible frequency.

The above-described flicker phenomenon is thought to be peculiar to a low-speed display device (such as, a cholesteric liquid-crystal display element), that performs rewriting to one line in the visible time (16.7 ms or more). For example, when a liquid crystal display device that is capable of displaying a moving image has a frame display speed of 16.7 or 33.3 ms and has 1000 lines, variations during rewriting to one line are invisible since the display speed per line is 16.7 or 33.3

It has also been known that application of a voltage having a corrected effective value to the signal electrodes (the segment electrodes) can correct shadowing (which is similar to flicker, in a still image) in a display device capable of displaying a moving image. More specifically, in the liquid crystal display device, a blanking period is provided in order to correct the shadowing resulting from variations in the voltage effective values of display dots on the selected line and a voltage having the corrected effective value is applied to the signal electrodes during the blanking period. Since the blanking period is provided at intervals of 16.7 ms, the frequency thereof is a visible frequency. However, the voltage applied when during non-selection period is determined by a difference between the signal voltage and the scan voltage; and thus, the effective value of the non-selection voltage is not corrected even when the effective value of the signal voltage is corrected. Even if the application of this correction technology is extended to the scan voltage and the effective value of the signal voltage and the effective value of the scan voltage are independently corrected, the effective value of the non-selection voltage cannot be corrected. This is because the non-selection voltage is determined by a difference between the signal voltage and the scan voltage and is not determined by a difference between the effective values.

The cholesteric liquid crystal display device according to an embodiment of the present invention will be described below in detail in reference to the accompanying drawings.

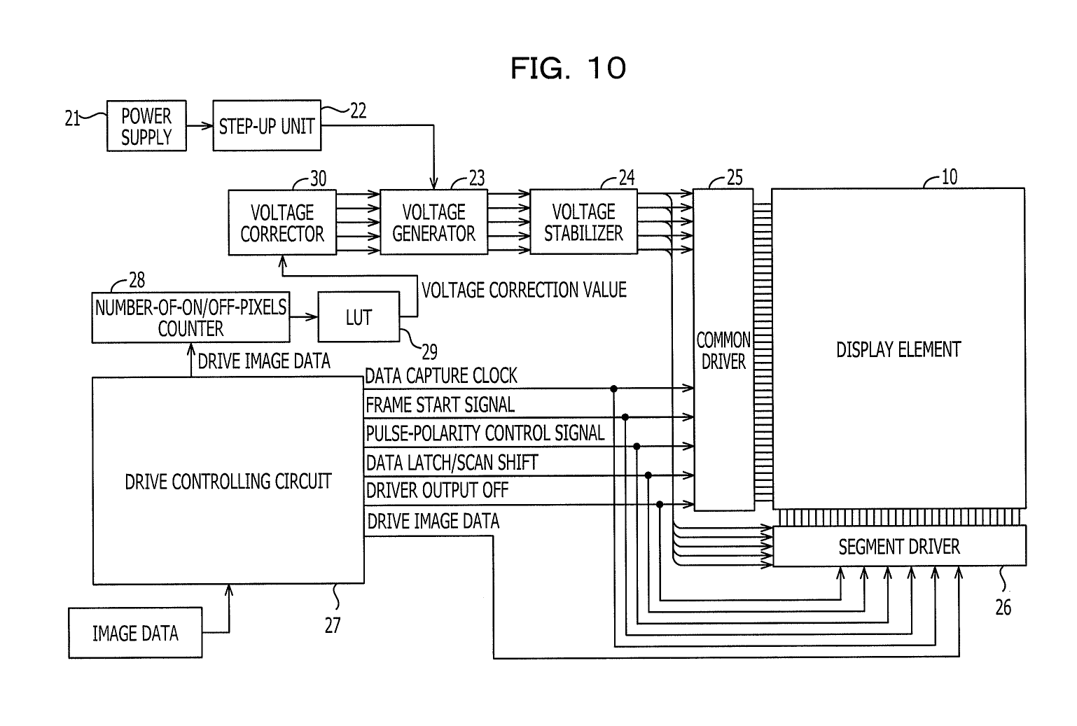

FIG. 10 is a block diagram illustrating a schematic configuration of a cholesteric liquid-crystal display device according to a first embodiment.

The cholesteric liquid crystal display device of the first embodiment has a display element 10, a power supply 21, a step-up unit 22, a voltage generator 23, a voltage stabilizer 24, a common driver 25, a segment driver 26, a drive controlling circuit 27, a number-of-on/off-pixels counter 28, a lookup table (LUT) 29, and a voltage corrector 30.

The display element 10 is a simple matrix color liquid-crystal display element using cholesteric liquid crystal.

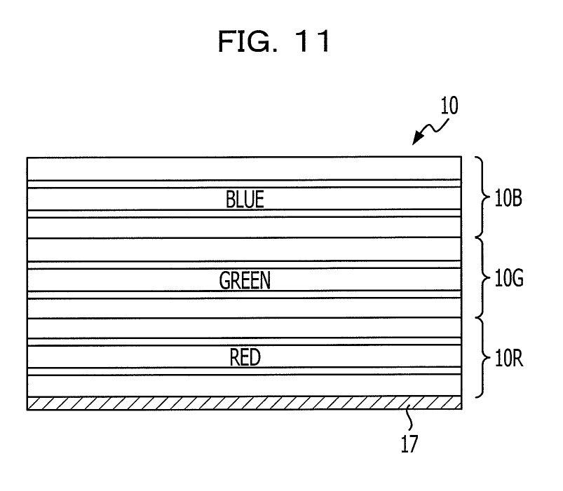

FIG. 11 illustrates the structure of the display element 10. As illustrated in FIG. 11, the display element 10 has three panels; (i.e., a panel 10B for blue, a panel 10G for green, and a panel 10R for red) stacked in sequence from the viewing side and also has a light absorption layer 17 provided below the panel 10R for red. Although the panels 10B, 10G, and 10R have substantially the same structure, liquid-crystal material and chiral material are selected and the content of the chiral material is determined so that the center wavelength of reflection of the panel 10B corresponds to blue (about 480 nm), the center wavelength of reflection of the panel 10G corresponds to green (about 550 nm), and the center wavelength of reflection of the panel 10R corresponds to green (about 630 nm). The common electrodes and the segment electrodes of the panels 10B, 10G, and 10R are driven by the common driver 25 and the segment driver 26.

That is, the panels 10B, 10G, and 10R have substantially the same structure, except that the center wavelengths of reflections thereof are different. The structure of the panel 10A will be described below as a representative example of the structures of the panels 10B, 10G, and 10R.

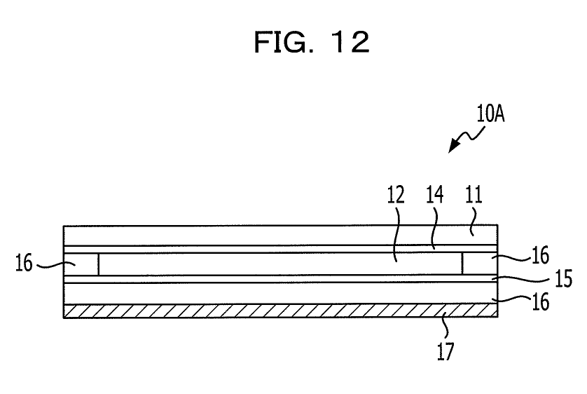

FIG. 12 illustrates a basic configuration of one panel 10A.

As illustrated in FIG. 12, the display element 10A has an upper substrate 11, an upper electrode layer 14 provided on a surface of the upper substrate 11, a lower electrode layer 15 provided on a surface of the lower substrate 13, and a sealant 16. The upper substrate 11 and the lower substrate 13 are disposed so that the electrodes oppose each other. Cholesteric liquid crystal material is enclosed between the upper substrate 11 and the lower substrate 13 and is sealed by the sealant 16. Spacers (not illustrated) are disposed in the cholesteric liquid crystal layer 12. One of the upper electrode layer 14 and the lower electrode layer 15 is provided with the common electrodes 18 and the other is provided with the segment electrodes 19. The common electrodes 18 are strip-shaped transparent electrodes that are parallel to each other and the segment electrodes 19 are strip-shaped transparent electrodes that are parallel to each other. The common electrodes 18 and the segment electrodes 19 are disposed so as to be perpendicular to each other when viewed from the observation surface. Voltage pulse signals are applied from the common driver 25 and the segment driver 26 to the common electrodes 18 and the segment electrodes 19, respectively, so that voltages are applied to the liquid crystal layer 12. As a result of application of the voltages to the liquid crystal layer 12, the liquid crystal molecules of the liquid crystal layer 12 are put into the planer state or the focal conic state for display.

Since simple matrix color cholesteric liquid-crystal display elements are widely known, a further description thereof is not given hereinafter.

It is assumed that the display element 10 is a CGA (color graphics adapter) device having 768 pixels high by 1024 pixels wide. The method for driving the display element 10 is the above-described conventional driving method (the first method), the pulse width of the write pulse is 10 ms, and the write pulse has a voltage as illustrated in FIG. 6D.

In reference to FIG. 10, the power supply 21 includes, for example, a battery or a unit that receives externally supplied power, and outputs a direct-current power of 3 to 5 V. The step-up unit 22 includes a DC-DC converter or the like and steps up the voltage of 3 to 5 V to about 40 V needed as a liquid-crystal drive voltage. It is preferable that this step-up unit 22 be one that exhibits a high conversion efficiency with respect to a load characteristic of the display element 10; (i.e., with respect to charging/discharging of the capacitor when the period is constant).

Using the stepped-up voltage, the voltage generator 23 generates a voltage of 36 V during the reset operation and generates an analog voltage (of about 0, 10, 17, or 24 V) during the write operation.

The voltage stabilizer 24 has a voltage follower circuit using an operational amplifier to stabilize the voltage during charging/discharging. It is preferable that the operational amplifier used be of a type that is tolerant of a capacitive load.

An output terminal of the common driver 25 is coupled to 768 common electrodes of the display element 10. An output terminal of the segment driver 26 is coupled to 1024 segment electrodes of the display element 10. Since each common electrode is selected by all of the three R, G, and B panels, the common driver 25 is shared by the three R, G, and B panels. In contrast, since pieces of image data supplied to the segment electrodes of the three R, G, and B panels are different from each other, each of the three R, G, and B panels is provided with the segment driver 26. The common driver 25 and the segment drivers 26 can be realized using general-purpose binary-outputting STN drivers and driver ICs are required to have a voltage resistance of 40 V or higher.

In order to rewrite an image displayed on the display element 10 on the basis of externally supplied image data, the drive controlling circuit 27 generates signals for controlling corresponding units and supplies drive image data to the segment drivers 26. Using an error diffusion method, the drive controlling circuit 27 converts an original full-color image (16,777,216 colors, with 256 gradations for each of R, G, and B) into 4096 colors with 16 gradations for each of R, G, and B to thereby generate the drive image data to be supplied to the segment drivers 26. Although many schemes are known for the gradation conversion, an error diffusion method or a blue noise mask method is preferable in terms of the display quality.

For rewriting a displayed image, a reset pulse with a voltage of ±36 V and with a pulse width of 15 ms is initially applied to all of the pixels eight times to perform a reset operation for putting the pixels into the planer state.

Next, the image data converted into 4096 colors are input to the segment drivers 26 for R, G, and B. For example, for a write operation employing a cumulative response, the image data of 4096 colors (16 gradations for each of R, G, and B) is split into pieces of binary image data (H1 to H7) corresponding to the respective halftones and the split binary data are written to the entire screen seven times. A voltage of ±24 V is applied to the pixels having gradation levels that are to be changed and a voltage of ±10 V, at which the liquid crystal does not respond almost at all, is applied to the pixels having gradation levels that are to be maintained.

Since the above-described configuration of the cholesteric liquid crystal display element is widely known, a detailed description is not given hereinafter.

In addition to the above-described configuration, the cholesteric liquid crystal display device of the first embodiment has the number-of-on/off-pixels counter 28, the lookup table (LUT) 29, and the voltage corrector 30. The number-of-on/off-pixels counter 28 receives the drive image data from the drive controlling circuit 27, counts the number of ON pixels (i.e., the number of black pixels) or the number of OFF pixels (i.e., the number of white pixels) on one line, and determines the ratio thereof, as needed. The number-of-on/off-pixels counter 28 may be realized using a digital addition-and-subtraction circuit or a microcomputer or may also be realized as part of a microcomputer or the like included in the drive controlling circuit 27.

The LUT 29 stores voltage correction values associated with the number of ON pixels or OFF pixels on one line or the ratio thereof. In accordance with a value output from the number-of-on/off-pixels counter 28, a corresponding voltage correction value is read from the LUT 29 and is output.

In accordance with the voltage correction value, the voltage corrector 30 finely adjusts voltages that the voltage generator 23 generates during the write operation, to thereby generate corrected voltages.

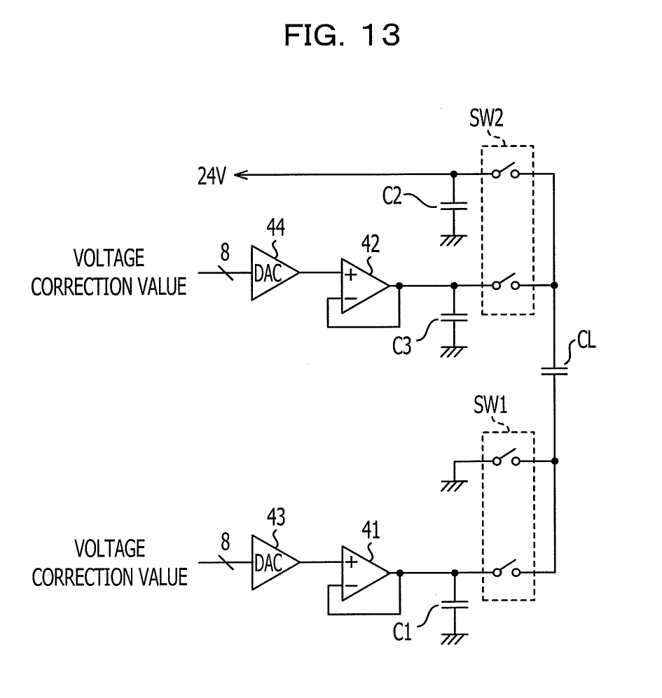

FIG. 13 is a diagram illustrating the structure of an output portion for the voltage corrector 30, the voltage generator 23, the voltage stabilizer 24, the common driver 25, and the segment driver 26 in the first embodiment. FIG. 13 corresponds to the circuit diagram at the left side in FIG. 8 and the circuit configuration illustrated in FIG. 13 is different from the configuration in FIG. 8 in that DACs (digital-to-analog converters) 43 and 44 are provided, except for the resistors R1 to R4. In the circuit illustrated in FIG. 8, a fixed voltage value is generated through voltage division performed by the resistors R1 to R4, but in contrast, in the circuit in FIG. 13, the DACs 43 and 44 included in the voltage corrector 30 generate voltages corresponding to the voltage correction value. The voltages generated by the DACs 43 and 44 are output to the voltage follower circuit, constituted by the operational amplifiers 41 and 42, and the voltage stabilizer 24, constituted by decoupling capacitors C1 and C3.

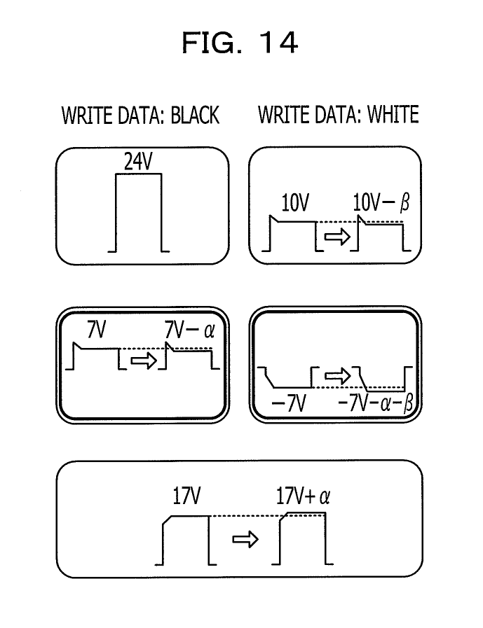

FIG. 14 illustrates voltage waveforms output from the common driver 25 and the segment driver 26 in the first embodiment and voltage waveforms applied to the liquid crystal pixels LC. The waveforms in FIG. 14 correspond to the waveforms at the right side in FIG. 8.

The upper-left voltage waveform represents a waveform output when an ON voltage of 24 V for the black pixels is output from the segment driver 26. The upper-right voltage waveform represents a waveform output when an OFF voltage of 10 V for the white pixels is output from the segment driver 26. The voltage waveform at the lower side represents a waveform output when a non-selection voltage of 17 V is output from the common driver 25. The left voltage waveform at the middle represents a waveform applied to the liquid crystal pixels CL when an ON voltage of 24 V is output from the segment driver 26. The right voltage waveform at the middle represents a waveform applied to the liquid crystal pixels CL when an OFF voltage of 10 V is output from the segment driver 26. In other words, the left and right voltage waveforms at the middle represent crosstalk voltages applied to the liquid crystal pixels CL.

As illustrated in FIG. 14, in the first embodiment, the non-selection voltage output from the common driver 25 is corrected so as to be 17 V+α when stabilized after an initial variation. The OFF voltage output from the segment driver 26 is also corrected so as to be 10 V−β when stabilized after the initial variation. The ON voltage output from the segment driver 26 is not corrected, since it stably outputs 24 V with a power supply that is capable of supplying a large amount of current.

Thus, the voltage waveform of the liquid crystal pixels CL on the unselected line when an ON voltage of 24 V is output from the segment driver 26 has 7 V−α when stabilized after the initial variation. The voltage waveform of the liquid crystal pixels CL on the unselected line when an OFF voltage of 10 V−β is output from the segment driver 26 has −7 V−α−β when stabilized after the initial variation.

As described above in reference to FIG. 8, the cumulative value of variations in the effective value of the voltage waveform of the liquid crystal pixels CL varies depending on the write data, thereby causing the occurrence of a flicker. Accordingly, when the values of α and β are adjusted according to the write data for one line so that the cumulative value of variations in the effective value becomes constant, no flicker occurs. In the first embodiment, the number-of-on/off-pixels counter 28 counts the number of ON/OFF pixels in the write data for one line and reads the voltage correction value corresponding to the count value, the voltage correction value being stored in the LUT 29, and the voltage corrector 30 performs voltage correction by an amount corresponding to the voltage correction value (that is, corrects α and β). As a result, the cumulative value of variations in the effective value becomes constant with respect to any write data for one line, so that flicker is reduced.

The amount of variation in electrical energy of a pulse applied, the variation being caused by an instantaneous voltage variation in the unselected lines, is uniquely determined by the number of ON/OFF pixels in the image data (segment data) for the selected line. In other words, α and β may be determined by the number of ON/OFF pixels in the image data for each selected line. A description below will be provided for a method for determining α and β on the basis of the number of ON/OFF pixels.

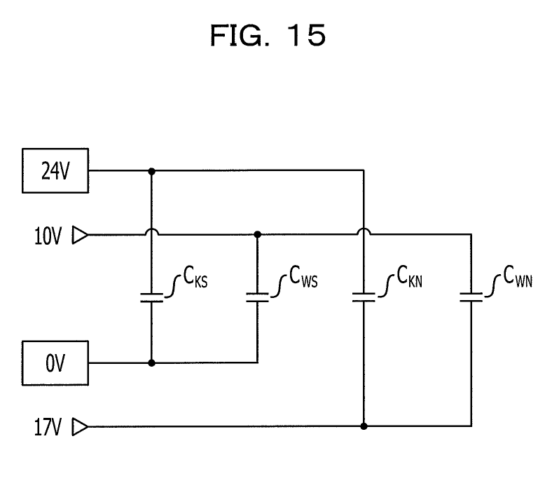

As described above, the liquid crystal display element 10 can be regarded as a collection of capacitances for liquid-crystal pixels. FIG. 15 is a diagram illustrating voltages applied to the capacitances for the liquid crystal pixels when the common driver 25 and the segment driver 26 drive the liquid crystal display element 10. The common driver 25 applies a voltage of 0 V to one selected line and applies a voltage of 17 V to 767 unselected lines and the segment driver 26 applies an ON voltage of 24 V to the segment lines for the black pixels on the selected line and applies an OFF voltage of 10 V to the segment lines for the white pixels on the selected line. In FIG. 15, C_{KS} indicates the total of, on the selected line, liquid crystal capacitances to which an ON voltage is applied and C_{WS} indicates the total of, on the selected line, liquid crystal capacitances to which an OFF voltage is applied. C_{KN} indicates the total of, on the unselected line, liquid crystal capacitances to which an ON voltage is applied and C_{WN} indicates the total of, on the unselected line, liquid crystal capacitances to which an OFF voltage is applied.

Since the number of selected lines is 1 and the number of unselected lines is 767, C_{KS} and C_{WS} are 1/767 of C_{KN} and C_{WN} and can thus be ignored. Accordingly, considering C_{KN} and C_{WN} is sufficient. In other words, the pixels on the selected line can be ignored. Hereinafter, C_{KN} is expressed by C_{K} and C_{WN} is expressed by C_{W}.

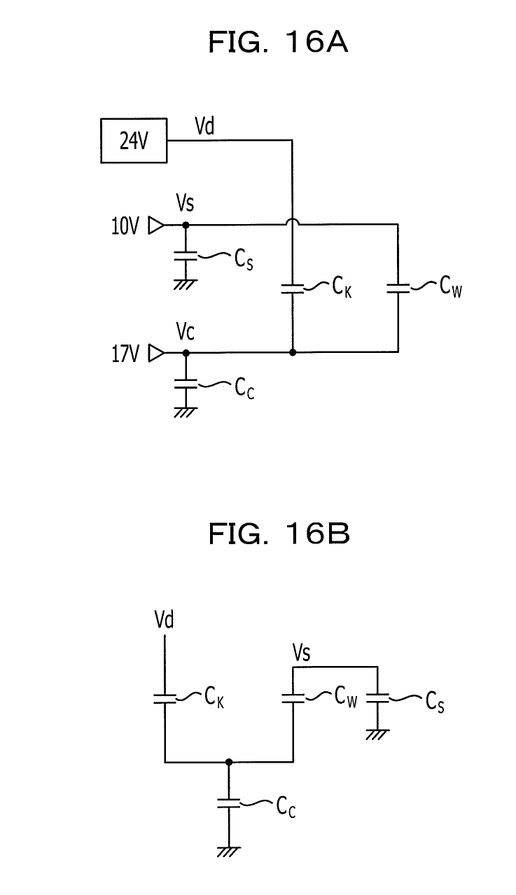

FIGS. 16A and 16B are diagrams illustrating the drive state of the display element 10 by using C_{K} and C_{W}. FIG. 16A further illustrates the capacitor C_{C} provided at the 17 V output portion of the common driver 25 and the capacitor C_{S} provided at the 10 V output portion of the segment driver 26.

The circuit in FIG. 16A is expressed in a form corresponding to the circuit in FIG. 15 and may also be expressed as in FIG. 16B.

It is now assumed that, before the terminal (electrode) for capacitance is connected to the power supply, electric charge given by Q_{S}=C_{S}Vs is stored in the capacitor C_{S}, electric charge given by Q_{C}=C_{C}Vc is stored in the capacitor C_{C}, and no electric charges are stored in the capacitors C_{K} and C_{W}.

Power is supplied to the circuits in FIGS. 16A and 16B via a Vd (24 V) terminal, a Vs (10 V) terminal, and a Vc (17 V) terminal. It is also assumed that the 17 V output portion of the common driver 25 and the 10 V output portion of the segment driver 26 become high impedances at the instant connection is made and power is supplied from the capacitors C_{C} and C_{S}.

Changes in the voltages applied to C_{K} and C_{W}, upon starting the power supply, are equivalent to a combination of changes when power is separately supplied from three terminals and can thus be determined by totaling the changes in the power supplied from the terminals.

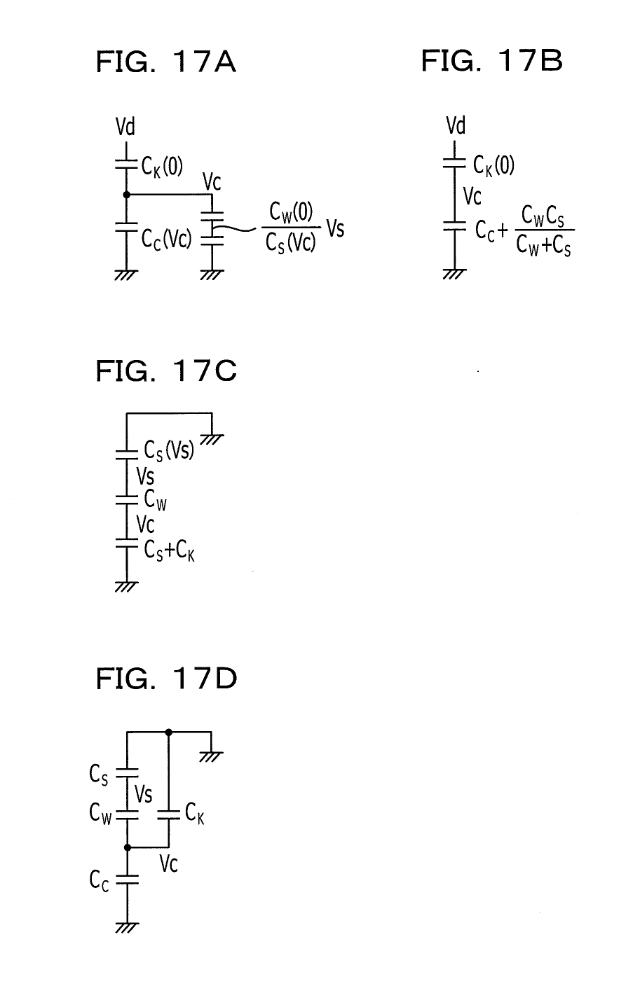

FIGS. 17A to 17D are diagrams illustrating the states of circuits for calculating changes due to power supplied from the terminals.

When power is supplied from the Vd (24 V) terminal, a relationship given by Q_{S}=Q_{C}=0 is satisfied and the connection enters a state as illustrated in FIG. 17A. The circuit in FIG. 17A can be expressed as the circuit in FIG. 17B. Based on FIGS. 17B and 17A, a voltage Vc1 at a terminal of C_{K}, the terminal being adjacent to the common driver 25, and a voltage Vs1 at a node of C_{W} and C_{S} are expressed by the following expressions:

$$Vc 1 = Vd \frac{1 / ( Cc + \frac{CwCs}{Cw + Cs} )}{1 / Ck + 1 / ( Cc + \frac{CwCs}{Cw + Cs} )}$$

$$Vs 1 = Vc \frac{1 / Cs}{1 / Cw + 1 / Cs}$$

When power is supplied from the Vs (10 V) terminal, a relationship given by Vd=Q_{C}=0 is satisfied and the connection enters a state as illustrated in FIG. 17C. In reference to FIG. 17C, electric charge C_{S}Vs stored in C_{S}, a voltage Vs2 at a node of C_{W} and C_{S}, and a voltage Vc2 at a node of C_{W} and C_{C} are given by the following expressions:

$$\begin{matrix}CsVs = CsVs + \frac{Cw ( Cc + Ck )}{Cw + Cc + Ck} Vs \\ = ( Cs + \frac{Cw ( Cc + Ck )}{Cw + Cc + Ck} ) Vs\end{matrix} \\ ∴ Vs 2 = Vs \frac{Cs}{Cs + \frac{Cw ( Cc + Ck )}{Cw + Cc + Ck}}$$

$$Yc 2 = Vs \frac{1 / ( Cc + Ck )}{1 / Cw + 1 / ( Cc + Ck )}$$

When power is supplied from the Vc (17 V) terminal, a relationship given by Vd=Q_{S}=0 is satisfied and the connection enters a state as illustrated in FIG. 17D. In reference to FIG. 17D, electric charge C_{C}Vc stored in C_{C}, a voltage Vc3 at a node of C_{S} and C_{W} and C_{K}, and a voltage Vs3 at a node of C_{W} and C_{S} are given by the following expressions:

$$\begin{matrix}CcVc = CcVc + ( Ck + \frac{CsCw}{Cs + Cw} ) Vc \\ = ( Cc + Ck + \frac{CsCw}{Cs + Cw} ) Vc\end{matrix} \\ ∴ Vc 3 = Vc \frac{Cc}{Cc + Ck + \frac{CsCw}{Cs + Cw}}$$

$$Vs 3 = Vc \frac{1 / Cs}{1 / Cs + 1 / Cw}$$

Summation of the voltages in the above-described three cases yields voltages Vc and Vs, as given by:

Vc=Vc1+Vc2+Vc3

Vs=Vs1+Vs2+Vs3

Calculations were performed with respect to a case in which the ratio of black pixels versus white pixels on a selected line was half and half (i.e., 50%), a case in which the ratio of black pixels was 90%, and a case in which the ratio of white black pixels was 90%, when the capacitance values of the capacitors C_{C} and C_{S} were 1 μF. Table 1 below indicates results of changes in voltages being applied to one selected line. Table 1 also indicates results of a case in which the ratio of black pixels versus white pixels on the selected line was half and half when the capacitance values of capacitors C_{C} and C_{S} were 10 μF.

TABLE 1

| | Decoupling | Decoupling | | |
|---|---|---|---|---|
| | Capacitor | Capacitor | Decoupling | Decoupling |
| | 10 μF | 1 μF | Capacitor | Capacitor |
| | Half White | Half White | 1 μF | 1 μF |
| | Half Black | Half Black | Black 90% | White 90% |
| Vd | 24 | 24 | 24 | 24 |
| Vs | 10 | 10 | 10 | 10 |
| Vc | 17 | 17 | 17 | 17 |
| Cs | 1.00E−05 | 1.00E−06 | 1.00E−06 | 1.00E−06 |
| Cc | 1.00E−05 | 1.00E−06 | 1.00E−06 | 1.00E−06 |
| Ck | 5.00E−07 | 5.00E−07 | 9.00E−07 | 1.00E−07 |
| Cw | 5.00E−07 | 5.00E−07 | 1.00E−07 | 9.00E−07 |
| Vc1 | 1.093 | 6.545 | 10.849 | 1.525 |
| Vs1 | 0.052 | 2.182 | 0.986 | 0.722 |
| Vc1_tmp | 1.05E−05 | 1.33E−06 | 1.09E−06 | 1.47E−06 |
| Vc2 | 0.418 | 1.818 | 0.789 | 3.311 |
| Vs2 | 9.544 | 7.273 | 9.132 | 6.689 |
| Vc2_tmp | 4.77E−07 | 3.75E−07 | 9.50E−08 | 4.95E−07 |
| Vc3 | 15.488 | 9.273 | 8.539 | 10.803 |
| Vs3 | 0.738 | 3.091 | 0.776 | 5.117 |
| Vc3_tmp | 4.76E−07 | 3.33E−07 | 9.09E−08 | 4.74E−07 |
| Vct | 16.999 | 17.636 | 20.177 | 15.639 |
| Vst | 10.334 | 12.545 | 10.895 | 12.528 |
| Vlc_ON | 7.001 | 6.364 | 3.823 | 8.361 |
| Vlc_OFF | −6.665 | −5.091 | −9.282 | −3.110 |
| T | 2.00E−03 | 2.00E−03 | 2.00E−03 | 2.00E−03 |
| Tr | 7.36E−07 | 6.36E−05 | 3.18E−04 | 1.36E−04 |
| Ic | 1.00E−2 | 1.00E−02 | 1.00E−02 | −1.00E−02 |
| A | 1 | 1 | 1 | 1 |
| B | −14 | −14 | −14 | −14 |
| C | −1.9E−06 | 0.137441 | 2.997943 | −0.690542 |
| b\hat{ }2-4*a*c | 196 | 195.4502 | 184.0082 | 198.76217 |
| sqrt( ) | 14 | 13.98035 | 13.56496 | 14.098304 |
| α | −1.4E−07 | 0.009824 | 0.217518 | −0.049152 |
| T | 2.00E−03 | 2.00E−03 | 2.00E−03 | 2.00E−03 |
| Tr | 3.34E−04 | 2.55E−04 | 8.95E−05 | 2.53E−04 |
| Is | 1.00E−2 | 1.00E−02 | 1.00E−02 | 1.00E−02 |
| A | 1 | 1 | 1 | 1 |
| B | −14 | −14 | −14 | −14 |
| C | 3.85E−01 | 1.99E+00 | 2.69E−01 | 1.97E+00 |
| b\hat{ }2-4*a*c | 194.4595 | 188.0254 | 194.9257 | 188.12546 |
| sqrt( ) | 13.94487 | 13.71224 | 13.96158 | 13.715883 |
| β | 0.027563 | 0.143882 | 0.01921 | 0.1420583 |

Table 1 also illustrates values of α and β, as described below.

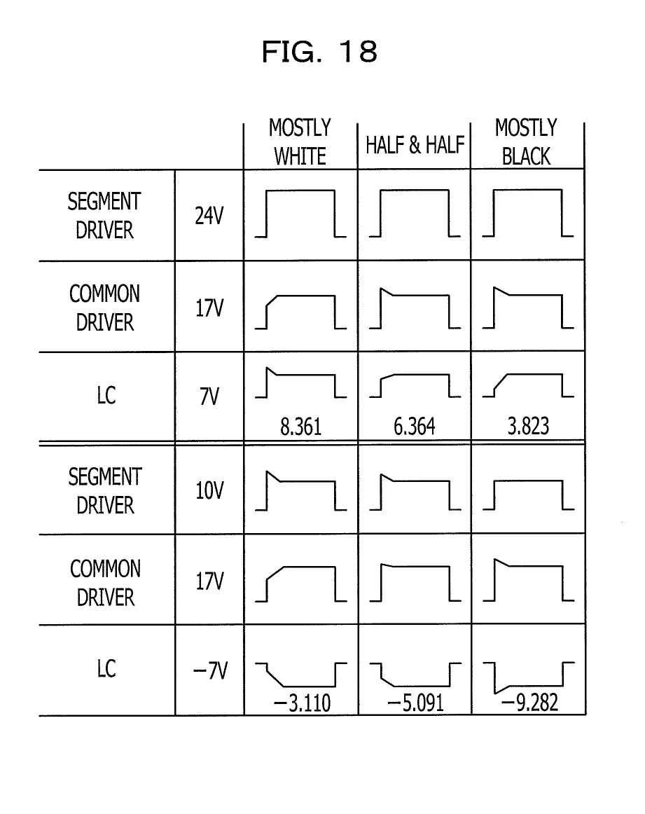

FIG. 18 illustrates changes based on the above-noted calculation results. In FIG. 18, the upper section illustrates a case in which a positive pulse is applied to the liquid crystal pixels and the lower section illustrates a case in which a negative pulse is applied to the liquid crystal pixels. Each of the portions illustrates a case in which most (90%) of the pixel data for the selected line are for white pixels, a case in which half (50%) of the pixel data are for white pixels and half of the pixel data are for black pixels, and most (90%) of the pixel data are for black pixels. For example, for application of the positive pulse, when most of the pixel data is for white pixels, the voltage applied to the liquid crystal pixels LC is initially 8.361 V, decreases to 7 V in the time of about 10% of the pulse width, and then stays at 7 V. For example, for application of the positive pulse, when the pixel data for white pixels and the pixel data for black pixels are half and half, the voltage applied to the liquid crystal pixels LC is initially 6.364 V, increases to 7 V in the time of about 10% of the pulse width, and then stays at 7 V.

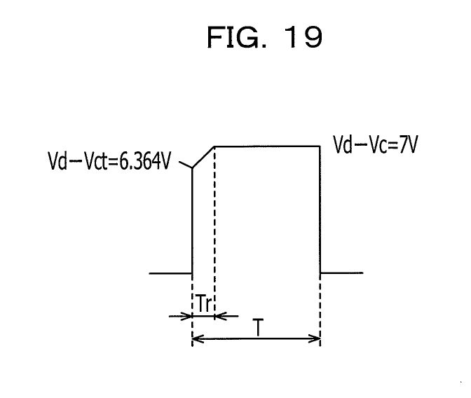

FIG. 19 illustrates a model of changes in the voltage applied to the liquid crystal pixels LC when the ratio of black pixels versus white pixels in the pixel data is half and half for application of a positive pulse. In this model, as illustrated in FIG. 19, the application time of the pulse is T, the voltage applied at the start of the pulse application is Vd−Vct=6.364 V, and the applied voltage increases linearly to Vd−Vc=7 V in the period of time Tr.

First, the model illustrated in FIG. 19 is used to determine α. As illustrated in FIG. 14, the effective value of the pulse in FIG. 19 when Vc is assumed to be corrected to Vc+α is expressed by an expression below, α is determined according to a procedure illustrated in the Table above, and α at which the effective value is Vd−Vc is determined.

$${( effective value )}^{2} = \frac{1}{T} [ {\int }_{0}^{Tr} {\{ Vd - Vct + ( Vct - Vc ) \frac{t}{Tr} \}}^{2} d t + {\int }_{Tr}^{T} {( Vd - Vc )}^{2} d t ] = {( Vd - Vc - α )}^{2} \\ where \\ \vert Vct - Vc \vert = \frac{IcTr}{Cc} ∴ Tr = \frac{Cc}{Ic} \vert Vct - Vc \vert$$

Ic indicates sink and source current of operational amplifier

$${\int }_{0}^{Tr} {( Vd - Vct )}^{2} d t + \frac{2}{Tr} {\int }_{0}^{Tr} ( Vd - Vct ) ( Vct - Vc ) t d t + \frac{1}{{Tr}^{2}} {\int }_{0}^{Tr} {( Vct - Vc )}^{2} {t}^{2} d t + {\int }_{Tr}^{T} {( Vd - Vc )}^{2} d t = {T ( Vd - Vc - α )}^{2}$$

$${Tr ( Vd - Vct )}^{2} + \frac{2}{Tr} \cdot \frac{{Tr}^{2}}{2} ( Vd - Vct ) ( Vct - Vc ) + \frac{1}{{Tr}^{2}} \cdot \frac{{Tr}^{3}}{3} {( Vct - Vc )}^{2} + ( T - Tr ) {( Vd - Vc )}^{2} = {T ( Vd - Vc - α )}^{2}$$

$$Tr ( {Vd}^{2} - 2 VdVct + {Vct}^{2} + VdVct - {Vct}^{2} - VdVc + VdVc + \frac{1}{3} {Vct}^{2} - \frac{2}{3} VctVc + \frac{1}{3} {Vc}^{2} ) + {T ( Vd - Vc )}^{2} - {Tr ( Vd - Vc )}^{2} = {T ( Vd - Vc - α )}^{2}$$

$$\begin{matrix}Tr \{ \frac{1}{3} {Vct}^{2} + \frac{1}{3} VctVc - VdVct + VdVc - \frac{2}{3} {Vc}^{2} \} = T \{ {( Vd - Vc - α )}^{2} - {( Vd - Vc )}^{2} \} = T \{ {α}^{2} - 2 α ( Vd - Vc ) \} \\ & ( 1 ) \\ ∴ {α}^{2} - 2 α ( Vd - Vc ) - \frac{Tr}{3 T} ( {Vct}^{2} + VctVc - 3 VdVct + 3 VdVc - 2 {Vc}^{2} ) = 0 & ( 2 ) \\ α = [ ( Vd - Vc ) - \sqrt{{( Vd - Vc )}^{2} + \frac{Tr}{3 T} ( {Vct}^{2 } + VctVc - 3 VdVct + 3 VdVc - 2 {Vc}^{2}} ] & ( 3 )\end{matrix}$$

In this case, β is determined according to the following procedure.

Although Vc varies, the effective value of Vd−Vc becomes equal to Vd−Vc corrected with α. Thus, when Vs is corrected to Vs−β, β may be determined so that the effective value of Vc−Vs is equal to Vc−Vs. This calculation can be realized using a procedure similar to that for α by replacing Vd, Vc, Vct, and α with Vc, Vs, Vst, and β, respectively. Calculation expression for β is expressed as follows:

$$Vd \to Vc$$

$$Vc \to Vs$$

$$Vct \to Vst$$

$$α \to β$$

$$\begin{matrix}{β}^{2} - 2 β ( Vc - Vs ) - \frac{Tr}{3 T} ( {Vst}^{2} + VstVs - 3 VcVst + 3 VcVs - 2 {Vs}^{2} ) = 0 \\ Tr = \frac{Cs}{Is} \vert Vst - Vs \vert & ( 4 ) \\ where & \\ β = [ ( Vc - Vs ) - \sqrt{{( Vc - Vs )}^{2} + \frac{Tr}{3 T} ( {Vst}^{2} + VstVs - 3 VcVst + 3 VcVs - 2 {Vs}^{2}} ] & ( 5 )\end{matrix}$$

The above table indicates the values of α and β as determined for the respective cases. With respect to all of the cases of the number of white pixels or the number of black pixels on the selected line or the ratio of white pixels versus black pixels, α and β are determined based on drive conditions of the display element 10. The voltage correction value for generating α and β is stored in the LUT 29 in association with the number of white or black pixels on the selected line or the ratio of the white pixels versus the black pixels. Since the number of white pixels on the selected line is 0 to 1024, the number of addresses is 1024 and; thus, 10 bits is sufficient.

Based on the drive image data to be sent to the segment driver 26, the number-of-on/off-pixels counter 28 determines the number of white or black pixels on the next selected line on which rewriting is to be performed or the ratio of the white pixels versus the black pixels. When the LUT 29 is accessed using the determined value, the voltage correction value is output and is supplied to the voltage corrector 30. The voltage corrector 30 and the voltage generator 23 generates Vs and Vc on the basis of the voltage correction value and supplies Vs and Vc to the common driver 25 and the segment driver 26. With this arrangement, Vs and Vd resulting from the correction of α and β are applied to each selected line, so that the cumulative value of variations in the effective value becomes constant, thereby reducing flicker.

Although the LUT 29 is used in the first embodiment, as described above, an arithmetic circuit or a microcomputer may be utilized to count the number of white or black pixels or the ratio thereof and the voltage correction value may be determined in accordance with the calculation expressions of α and β.

Although both of Vs and Vc are corrected in the first embodiment, merely correcting Vc also provides an advantage in the correction.

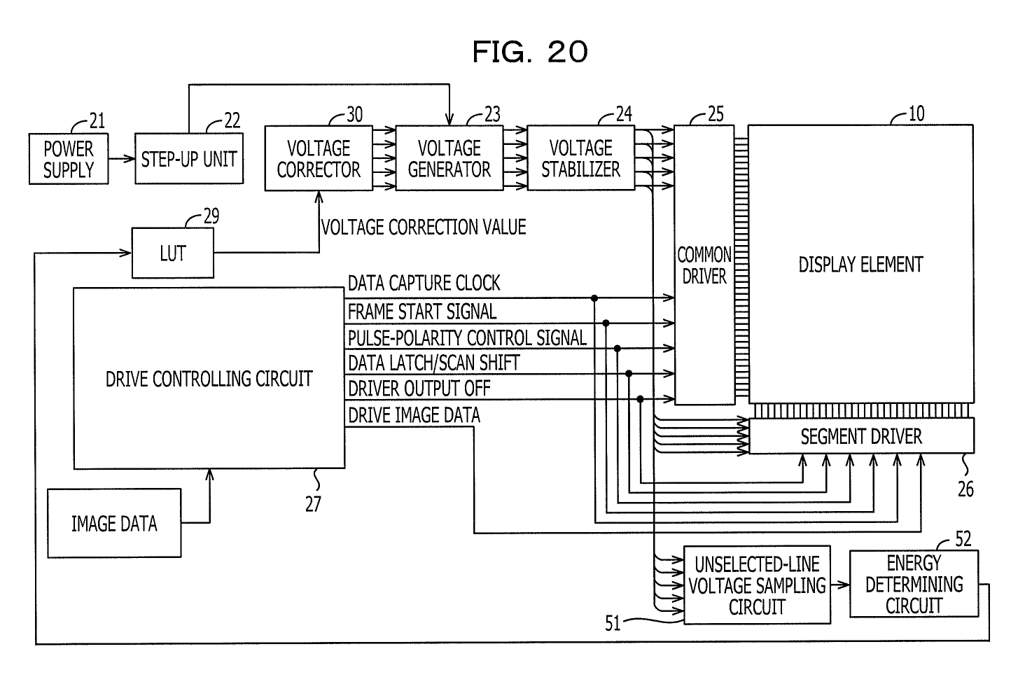

FIG. 20 is a block diagram of a schematic configuration of a cholesteric liquid crystal display device according to a second embodiment

The cholesteric liquid crystal display device of the second embodiment is substantially the same as the device in the first embodiment and is different therefrom in that an unselected-line voltage sampling circuit 51 and an energy determining circuit 52 are provided instead of the number-of-on/off-pixels counter 28.

The unselected-line voltage sampling circuit 51 detects a voltage difference between the unselected line (electrode) and the segment electrode to which the ON voltage is applied and also detects a voltage difference between the unselected common line (electrode) and the segment line (electrode) to which the OFF voltage is applied. As described above, during the writing to one line, a voltage variation occurs at an early stage. The time required for the writing of one line is 10 ms or more. Detection of the voltage variation at the early stage and the feedback of the voltage variation makes it possible to perform correction sufficiently.

Based on the detected voltage difference, the energy determining circuit 52 determines the amount of variation in the electrical energy of an applied corresponding pulse. The LUT 29 stores voltage correction values determined from the amounts of variation in the electrical energy in association with the amounts of variation in the electrical energy. The energy determination can be easily realized using the lookup table in which the amounts of variation in the electrical energy of the applied pulse associated with voltage variation values are pre-stored. Alternatively, the energy determination may also be realized through calculation using an arithmetic circuit or a microcomputer.

As described above, the first and second embodiments allow a memory display element using cholesteric liquid crystal to perform high-speed image display with a reduced amount of flicker. For large-size panels in particular, it is possible to reduce the cost, to achieve miniaturization, and to extend the battery operating time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A cholesteric liquid-crystal display device, comprising:
a cholesteric liquid-crystal display element having common electrodes and segment electrodes;
a common driver which drives the common electrodes, outputs a selected-line voltage to a selected line of the common electrodes, and outputs an unselected-line voltage to unselected lines other than the selected line;
a segment driver which drives the segment electrodes and outputs a write signal to the segment electrodes;
a drive controlling circuit which controls the common driver and the segment driver to rewrite an image displayed on the cholesteric liquid-crystal display element; and
a voltage correcting circuit which corrects the unselected-line voltage corresponding to the write signal during writing to the selected line.

2. The cholesteric liquid-crystal display device according to claim 1, wherein an output period of the voltage correcting circuit is at most an inverse of a visible frequency.

3. The cholesteric liquid-crystal display device according to claim 1, wherein, during the writing to the selected line, the voltage correcting circuit corrects a write-line voltage for pixel data for the selected line in accordance with the write signal that the segment driver outputs during writing to the selected line, the write-line voltage being output by the segment driver.

4. The cholesteric liquid-crystal display device according to claim 3, wherein the voltage correcting circuit corrects an off voltage of the write-line voltage.

5. The cholesteric liquid-crystal display device according to claim 1, further comprising:
a variation detecting circuit which detects an amount of variation in electrical energy of a pulse applied, the variation being caused by a voltage variation having a shorter period than a period corresponding to a visible frequency of the unselected lines; and
a correction-value determining circuit which determines a correction value for the unselected-line voltage in accordance with the amount of variation in the electrical energy, the amount of variation being detected by the variation detecting circuit;
wherein the voltage correcting circuit controls the unselected-line voltage in accordance with the correction value determined by the correction-value determining circuit.

6. The cholesteric liquid-crystal display device according to claim 3, further comprising:
a variation detecting circuit which detects an amount of variation in electrical energy of a pulse applied, the variation being caused by a voltage variation having a shorter period than a period corresponding to a visible frequency of the unselected lines; and
a correction-value determining circuit which determines a correction value for the unselected-line voltage and the write-line voltage in accordance with the amount of variation in the electrical energy, the amount of variation being detected by the variation detecting circuit,
wherein the voltage correcting circuit corrects the unselected-line voltage and the write-line voltage in accordance with the correction value determined by the correction-value determining circuit.

7. The cholesteric liquid-crystal display device according to claim 5, wherein the variation detecting circuit determines the amount of variation in the electrical energy based on a count value of the number of on pixels or the number of off pixels on one selected line.

8. The cholesteric liquid-crystal display device according to claim 7, wherein the correction-value determining circuit determines the correction value by using a lookup table in which the correction value is stored in association with the number of on pixels or the number of off pixels.

9. The cholesteric liquid-crystal display device according to claim 5, wherein the variation detecting circuit determines the amount of variation in the electrical energy based on a voltage difference between the unselected-line voltage and a write-line voltage for pixel data to which an on voltage is applied and a voltage difference between the unselected-line voltage and a write-line voltage for pixel data to which an off voltage is applied.

10. The cholesteric liquid-crystal display device according to claim 9, wherein the correction-value determining circuit determines the correction value by using a lookup table in which the correction value is stored in association with the voltage differences.

11. A simple matrix driving method for a cholesteric liquid-crystal display element which outputs a selected-line voltage to a selected line of common electrodes of the cholesteric liquid-crystal display element, which outputs an unselected-line voltage to unselected lines other than the selected line, and which outputs a write signal to segment electrodes in synchronization with the outputs of the selected-line voltage while shifting a position of the selected line, the method comprising:
determining a correction value for the unselected-line voltage in accordance with the write signal output to the selected line; and
correcting the unselected-line voltage in accordance with the determined correction value during writing to the selected line.

12. The simple matrix driving method according to claim 11, wherein an application period of the unselected-line voltage has a value close to an inverse of a visible frequency.

13. The simple matrix driving method according to claim 11, wherein, during writing to the selected line, a write-line voltage for the pixel data is corrected in accordance with the write signal output to the selected line during writing to the selected line.

14. The simple matrix driving method according to claim 13, wherein the write-line voltage corrected is an off voltage.

15. The simple matrix driving method according to claim 11, wherein the correction is performed by detecting an amount of variation in electrical energy of a pulse of the unselected-line voltage, the variation being caused by a voltage variation having a shorter period than a period corresponding to a visible frequency, determining a correction value for the unselected-line voltage in accordance with the detected amount of variation in the electrical energy, and controlling the unselected-line voltage in accordance with the determined correction value.

16. The simple matrix driving method according to claim 13, wherein the correction is performed by determining an amount of variation in electrical energy of a pulse of the unselected-line voltage and the write-line voltage, the variation being caused by a voltage variation having a shorter period than a period corresponding to a visible frequency, determining a correction value for the unselected-line voltage and the write-line voltage in accordance with the determined amount of variation in the electrical energy, and controlling the unselected-line voltage and the write-line voltage in accordance with the determined correction value.

17. The simple matrix driving method according to claim 15, wherein the amount of variation in the electrical energy is determined based on a count value of the number of on pixels or the number of off pixels on the selected line.

18. The simple matrix driving method according to claim 17, wherein the correction value for the unselected-line voltage is determined using a lookup table in which the correction value is stored in association with the number of on pixels or the number of off pixels.

19. The simple matrix driving method according to claim 15, wherein the amount of variation in the electrical energy is determined based on a voltage difference between the unselected-line voltage and a write-line voltage for pixel data to which an on voltage is applied and a voltage difference between the unselected-line voltage and a write-line voltage for pixel data to which an off voltage is applied.

20. The simple matrix driving method according to claim 19, wherein the correction value for the unselected-line voltage is determined using a lookup table in which the correction value is stored in association with the voltage differences.
